(19) United States
(12) Patent Application Publication
(10) Pub. No.: US 2017/0323406 A1
(43) Pub. Date: Nov. 9, 2017

(54) System and Method for Coordinating, Facilitating, and Providing Relocation Services Through the Use of a Computing Device, Including Portable Computing Devices

(71) Applicants: Jeanette A. Broz, Washington, DC (US); Anne E. Wright, Denver, CO (US)

(72) Inventors: Jeanette A. Broz, Washington, DC (US); Anne E. Wright, Denver, CO (US)

(21) Appl. No.: 15/149,159

(22) Filed: May 8, 2016

(51) Int. Cl. G06Q 50/16; G06Q 10/10

(52) U.S. Cl. CPC G06Q 50/16; G06Q 10/105

(57) ABSTRACT

The present invention outlines an online software application, agnostic to hardware or operating system (web, iPhone, iPad, laptop, tablet, or Android based) that provides an efficient one-stop, internet-based system; said system gathering into one information portal all significant information important to an efficient and successful move, and tailoring the information provided to the relocating individual according to their personal need and tastes through a front-end questionnaire that drives software algorithms.

The disclosed invention assists a relocating individual (including family, friends, or other associations, hereinafter collectively known as the “RI”), and/ or their employer, and/or assisting relocation specialists, in an efficient, cost-effective, and successful relocation from their current community, residence, and place of work, to a new community, residence, and place of work that is optimally compatible with the RI's desires and preferences.

The software and system application that is the subject of the present invention connects the RI to a new community and new residence that is compatible and suited to their stated lifestyle preferences, and which is determined though the RI's responses to a battery of key questions that is then used as input to a set of proprietary algorithms. The questions are defined to elicit from the RI their stated preferences for the type of new residence desired, commuting time and mode, household budget, important lifestyle choices (e.g. proximity to desired community infrastructure, such as schools, restaurants and recreation, and a variety of other key relocation variables known to relocation specialists skilled in the art), that are influential in forming and ensuring the compatibility of the RI and family to their new community.

The software employs a number of algorithms, said algorithms considered part of the present invention, that down-select from a variety of new communities and new residential choices within a larger set of possible communities, those specific communities and residences that optimally fulfill the preferences and desires of the relocating individual and/or their family. The selection algorithms that optimize the compatibility of the new communities and new residences to the RI make use of the responses provided by the RI in a questionnaire that is considered part of the present invention.

The output depiction from the down-selecting algorithm(s) can take the form a list of possible compatible communities and residences, and/or a graphical representation of said compatible communities and residences, such as a map, or other depiction, said output not limited by the depiction employed, and the range of possible depictions as output from the algorithms is also considered part of the present invention.

Efficiency, cost-effectiveness and speed are attained by quickly establishing with a high probability that the communities, and residences down-selected by the algorithms that are part of the subject of this invention, are a good fit with the stated preferences, budget, and lifestyle choices of the RI. This eliminates “false starts” and failed relocations, where the RI is unhappy with their new location and returns to their initial location because of incompatibility with the new community, or their productivity is diminished by their (or family's) unhappiness with the new community or residence. By ensuring a high probability of compatibility, the RI and their employer save the potential costs of multiple trials of new communities and new residences, plus the downtime and work inefficiencies that potentially result of multiple relocations, or from the RI's unhappiness in their new community leading to inefficiencies at their workplace a the RI grapples with resolving relocation issues. Speed results from guiding and connecting the RI to the correct community and residence ab initio, without guesswork and multiple reconnaissance trips to assess the RI's compatibility with the new community, or “hunt and peck” searching for the new residence. Additional efficiency results from other information provided by the online, web-based software regarding the acquisition of important documents such as driver's licenses, social security cards, visas, utilities connections, school registration, medical care, and a host of other relocation-associated decisions and paperwork.

### BACKGROUND

The global mobility (or “relocation”) industry is dominated by bureaucratic-heavy, multi-transactional, paper-driven/ email-driven providers and processes that are inefficient and unnecessarily expensive, burdensome, and slow. Problems with a given relocation are communicated through a chain of “middlemen” organizations, each involved with a separate transaction element, and each adding overhead to the total cost of the relocation. Information delivery to the Relocatiiong Individual (“RI”) is often slow, and many times ill-informed, requiring the RI to make multiple trips to registration offices, etc., due to incomplete documentation in-hand. The present invention will provide a comprehensive listing of required documents for individuals so that they have all required materials in their possession for such visits to government, school, and medical offices to conduct official business and complete necessary registrations.

### DESCRIPTION OF THE INVENTION

The global mobility industry needs an integrated software solution that transparently integrates and fuses all relocation transactions by all participants, bringing open-market benefits and competitiveness to the process. Employers need better cost control and improved expense reporting, with higher accountability. Employers need to reduce employee work disruption and relocation time by 50%, while increasing assignment satisfaction and relocation success. Employees need rapid resolution of relocation problems encountered; communication of problems and solutions must be rapid, accurate and thorough.

Employees need large amounts of local information which is currently fragmented (and often in local languages). The present invention provides an automated means for efficiently accomplishing all aspects of the relocation cycle in a user-friendly manner to the RI, as well as to the employer, and enhances the efficiency of the relocation consultant, if one is engaged by the RI.

### ELEMENTS OF THE INVENTION

The invention is a software, internet-based application that assists individuals and their families in relocation (the Relocating Individual “RI”). The software consists of at least three parts: The Questionnaire (“Q”), the Algorithm (or Algorithms, “A”), and the Selection output (“S”). Each of the elements is described below and the function and interrelationship of the elements is further described and outlined.

The questionnaire “Q” is designed to extract from the RI the important information that drives or determines the selection of a specific community or set of residence choices for an RI; said information used in the algorithm “A”. Additionally, the responses to Q prompt the software to engage other decision tree algorithms “A” regarding, for example, the following items: foreign visas (if an international relocation); schools, (if the RI has children); drivers licenses, (if the RI drives), and likewise for a number of relocation issues important to resolve for the RI's successful move. The questions contained in Q would be envisioned to include information about age, marital status, type of residence desired, community variables (urban/sub-urban), proximity to schools (if the RI responds affirmative to questions about school-age children in the Q), proximity to recreational facilities, friends, recreational interests, nightlife, and a host of other preference variable known to relocation specialists skilled in the art.

The Algorithm “A” quantitatively selects from a list of all potential communities and residences within those communities, those best fitted to the RI based upon their responses to the questions in Q. Multiple algorithms may be employed to make the selection, and the algorithms stated as examples in this provisional application do not limit the scope of all potential algorithms that might be employed by the subject invention. Two algorithms believed to be most useful and employable to the present invention are outlined and described further below.

The output from the selection process engaged by the algorithm(s) “A” results is a listing, map, or other depiction of the selected residences and communities, said selection denoted as “S”. The invention ideally would have an output format most useful to the RI and interpretation of the results, such as a map of highly compatible residences, but the invention is not limited to said depictions such as maps. S can be a wide variety of outputs.

### ALGORITHMS IN DETAIL AND EXAMPLES

The algorithms “A” considered for completeness in this initial embodiment of the invention are three-fold:

Compatibility Algorithm A1 is an algorithm that characterizes each RI and community “C” with a three-dimensional vector according to the RI's responses to the questionnaire Q along the dimensions of (age, marital status, urban status). Assigning a range of (young, old)=(1, −1); (single, married)=(1, −1); and (urban, suburban)=(1, −1) allows characterization of an individual to a vector in this 3D space. More dimensions can be added to an arbitrarily large number. Weighting into a quadrant of this multi-dimensional space provides a simple way to segregate the subsets of available housing that have the highest probability of satisfying the RI, since the housing markets are also segregated in this multi-dimensional space according to the selected parameters.

For concreteness, in this simple 3D example, a young, single, urban professional who responded to the questions in Q would receive a vector valued as (1,1,1). Similarly, an urban community that is known to be populated with young urban professionals (say as an example 14th Street in DC) would also receive a (1,1,1) characterization, while an older married executive with children desiring to live in the suburbs (for example Bethesda, Md.) in a single-family house with a lawn would receive a (−1, −1, −1).

Under algorithm A1, the compatibility measure is determined by the standard dot-product of the RI and C community vectors. For example, the product of the young urban professional with the 14th Street community would be given as: C*RI=1*1+1*1+1*1=3, whereas this same individual's dot product with the Bethesda community would yield '13 (=1*−1+1*−1+1*−1). Normalization of these inner products will provide a final answer in the form of a total compatibility score. The algorithm weights a compatible score as vector products of RI's and C's having, for example, an inner product of at least 2 or greater (or 0.66 in the normalized case).

Using this vector product compatibility algorithm A1, the compatibility of a given individual with a given community can be assessed along a probability scale, and a gross, overall level of compatibility can be determined.

The utility of a compatibility algorithm is not constrained to the specific type of vector space calculation given as an example for algorithm A1, and the patent is not limited to the specific algorithm examples provided.

Algorithm A2 employs Boolean logic to determine the specific residences that the RI might be best positioned to visit and consider. Algorithm A2 begins with the input from Q as to what is most important to the RI—Commuting time to work, distance from school, proximity to recreation, friends, etc. Based upon the RI's response as to the most important factor, a centralized address or “pivoting datum” is the used to initiate the algorithm. Suppose in Q the RI responds that commuting time to work is the most important factor and that they desire a maximum 30 minute commute. Algorithm A2 the draws a perimeter around the work address for all commutes within 30 minutes (which may or may not be a circle around the work address datum because of faster commutes along certain routes). Based on information about budget, type of home, and other factors, the set of residences within this perimeter is then reduced to those meeting, or closest to, the selection criteria designated by the RI. In one embodiment of the present invention, the RI can weight the responses in Q with a sliding scale to emphasize the importance of certain relocation criteria and living situation characteristics most important to them.

Algorithm A3 employs questions that are included in Q that are based on the RI's current lifestyle and desired future lifestyle. The algorithm A3 employs Bayesian formalisms to infer what would be the most likely probable location given the current evidential conditions of the RI's existing living situation, as well as certain questions from Q that might indicate a change is desired. For example, A3 could be an algorithm that infers that if an RI currently lives in an urban setting that they might want to continue living in an urban setting in their new location; or alternatively, if the RI responds to questions that indicate a desired change of lifestyle, the algorithm might invoke conditional probabilities that would support a different type of lifestyle and thereby produce alternative selections for housing on a priority basis other than that normally selected.

Nothing in the foregoing examples limits the patent to any or all of the three algorithms provided as examples; More algorithms can be envisioned, and algorithms different than those outlined can be utilized.

We claim:

1. A software or code (“C”), that is web-based, online, or hosted on distributed application platforms, such as laptops, tablets or smart phones, that is designed to facilitate and streamline the relocation process for a Relocating Individual (“RI”) and is comprised of a questionnaire (“Q”), a set of algorithms (“A”), and guiding output (“S”) from said algorithms based upon input from “Q”.

2. That the Relocating Individual “RI” of claim 1 may represent a plurality of individuals, such as a family or couple, and that the method of claim 1 is not limited to single persons.

3. That the output “S” of claim 1 expeditiously facilitates the location of the RI's new dwelling and their relocation to that new dwelling.

4. That the output “S” of claim 1 enhances the “RI's” overall satisfaction with their new dwelling, and the speed of relocation.

5. That the output “S” of claim 1 assists the RI with matters and issues such as school selection, proximity to work, commuting time, recreational activities, and a host of other lifestyle conditions and priorities set by the RI.

6. That the output “S” of claim 1 is based upon the analysis performed by algorithms “A”, which in-turn depend on the specific inputs given by the RI's responses to “Q”.

7. That the questionnaire “Q” of claim 1 allows the RI to set the priorities and

5. le conditions as described by claim 5, and is minimally complicated for the RI to provide their responses.

8. That the algorithms “A” of claim 1 are useful in taking the data from “Q” and determining the output “S” that will statistically provide the RI with an enhanced probability of a satisfactory and expeditious move as compared to other methods of relocation facilitation, such as those practiced traditionally.

9. That the software “C” of claim 1 provides the questionnaire “Q” to the RI in a user-friendly format, including the potential use of “sliding” weights that allow the RI to state how relatively important certain responses in “Q” might be as compared to other responses.
